(19) United States
(12) Patent Application Publication
(10) Pub. No.: US 2017/0155411 A1
(43) Pub. Date: Jun. 1, 2017

(54) ELECTRONIC DEVICE SHELL WITH UNRESTRICTED TRANSMISSION CAPABILITY

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: HSIEN-PEI LUNG, New Taipei (TW); WU-ZHE YU, Shenzhen (CN)

(21) Appl. No.: 15/083,495

(22) Filed: Mar. 29, 2016

(30) Foreign Application Priority Data
Nov. 30, 2015 (CN) 201510857913.X

(51) Int. Cl. H04B 1/03

(52) U.S. Cl. CPC H04B 1/03

(57) ABSTRACT

A housing for an electronic device includes a main body configured to receive an electronic device and a wireless transmitter configured to send and receive wireless signals. An opening or recess is located on the outside surface of the main body, the opening or recess being covered with a cover made of radiation-transparent material. The wireless transmitter is received in the recess and is electrically connected with the electronic device to function.

### CROSS-REFERENCE TO RELATED APPLICATIONS

This application claims priority to Chinese Patent Application No. 201510857913.X filed on Nov. 30, 2015, the contents of which are incorporated by reference herein.

### FIELD

The subject matter herein generally relates to electronic devices, and more particularly to device housings.

### BACKGROUND

The material of the electronic device shell is usually of metal for strength and protection. This will weaken the ability to send and receive wireless signals of the wireless transmitter.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of an electronic device shell.

FIG. 2 is an assembled, isometric view of the electronic device shell of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

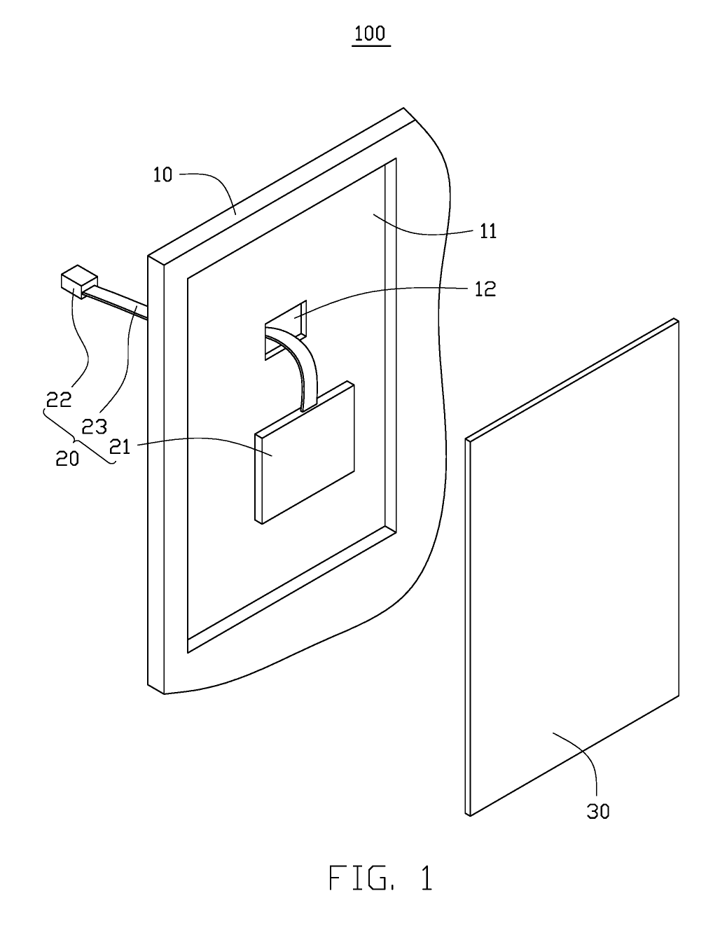

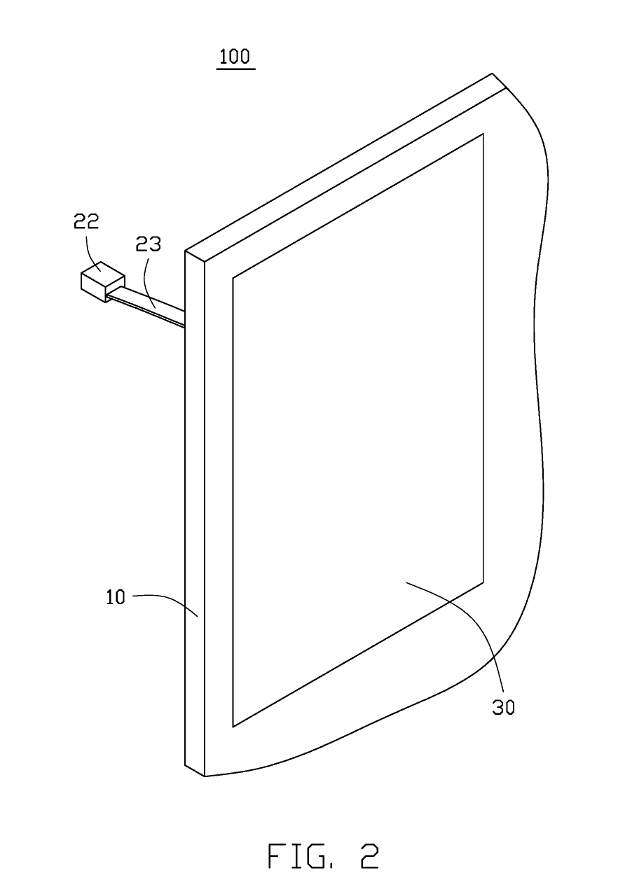

FIGS. 1 and 2 illustrate one embodiment of an electronic device shell 100 which includes a main body 10 configured to receive an electronic device (not shown), a wireless transmitter 20 configured to send and receive wireless signals, and a cover plate 30 detachable installed on the main body 10.

A recess 11 extends from the outside surface of the main body 10 to the interior. The wireless transmitter 20 is received in the recess 11. An opening 12 is located in the recess 11 to let the wireless transmitter 20 pass through. In at least one embodiment, the material of the main body is of metal material for impact protection and for radiation shielding of the electronic device. Further, the metal material can be iron, aluminum, or their alloys.

The wireless transmitter 20 includes a signal terminal 21, a connector 22, and a connecting line 23 connecting the signal terminal 21 with the connector 22. The signal terminal 21 is received in the recess 11 to send and receive wireless signals. The connector 22 is configured to pass through the opening 12 of the recess 11 to be electrically connected with the electronic device.

The shape of the cover plate 30 is similar to the shape of the recess 11 to fully cover the recess 11. The cover plate 30 is secured on the recess 11 to cover the wireless transmitter 20, and the cover plate 30 is substantially flush with the main body 10. In at least one embodiment, the material of the cover plate 30 is non-metallic. Further, the non-metallic material can be plastic.

FIGS. 2 illustrates assembly, when the connector 22 of the wireless transmitter 20 passes through the opening 12 of the recess 11 to be electrically connected with the electronic device. The signal terminal 21 and the connecting line 23 are received in the recess 11. The cover plate 30 is secured on the recess 11 to cover the wireless transmitter 20, and the cover plate 30 is in the same plane as the main body 10. The electronic device shell 100 is thus completely assembled.

The embodiments shown and described above are only examples. Many details are often found in the art such as the other features of an electronic device shell. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An electronic device shell comprising:
a main body configured to receive an electronic device; and
a wireless transmitter configured to send and receive a wireless signal;
wherein a recess extends from the outside surface of the main body, and the wireless transmitter is received in the recess and electrically connected with the electronic device.

2. The electronic device shell of claim 1, wherein the wireless transmitter comprises a signal terminal configured to send and receive the wireless signal, and the signal terminal is received in the recess.

3. The electronic device shell of claim 2, wherein an opening is located in the recess, the wireless transmitter can pass through the opening to be electrically connected with the electronic device.

4. The electronic device shell of claim 3, wherein the wireless transmitter comprises a connector, and the connector can pass through the opening to be electrically connected with the electronic device.

5. The electronic device shell of claim 4, wherein the wireless transmitter further comprises a connecting line to connect the connector with the signal terminal.

6. The electronic device shell of claim 1, wherein the electronic device shell further comprises a cover plate, and the cover plate is secured on the recess to cover the wireless transmitter.

7. The electronic device shell of claim 6, wherein the cover plate is secured on the recess, and the cover plate is in the same plane as the main body.

8. The electronic device shell of claim 6, wherein the material of the cover plate is non-metallic material in favor of the wireless transceiver sending and receiving the wireless signals.

9. The electronic device shell of claim 1, wherein the material of the main body is metallic material to enhance the fall prevention and radiation protection of the electronic device.

10. The electronic device shell of claim 9, wherein the metal material is iron, aluminum or its alloy.

11. An electronic device module, comprising:
an electronic device; and
an electronic device shell comprising:
a main body configured to receive the electronic device; and
a wireless transmitter configured to send and receive the wireless signal;
wherein a recess extends from the outside surface of the main body, and the wireless transmitter is received in the recess and electrically connected with the electronic device.

12. The electronic device module of claim 11, wherein the wireless transmitter comprises a signal terminal configured to send and receive the wireless signal, and the signal terminal is received in the recess.

13. The electronic device module of claim 12, wherein an opening is located in the recess, the wireless transmitter can pass through the opening to be electrically connected with the electronic device.

14. The electronic device module of claim 13, wherein the wireless transmitter comprises a connector, and the connector can pass through the opening to be electrically connected with the electronic device.

15. The electronic device module of claim 14, wherein the wireless transmitter further comprises a connecting line to connect the connector with the signal terminal.

16. The electronic device module of claim 11, wherein the electronic device shell further comprises a cover plate, and the cover plate is secured on the recess to cover the wireless transmitter.

17. The electronic device module of claim 16, wherein the cover plate is secured on the recess, and the cover plate is in the same plane as the main body.

18. The electronic device module of claim 16, wherein the material of the cover plate is non-metallic material in favor of the wireless transceiver sending and receiving the wireless signals.

19. The electronic device module of claim 11, wherein the material of the main body is metallic material to enhance the fall prevention and radiation protection of the electronic device.

20. The electronic device module of claim 19, wherein the metal material is iron, aluminum or its alloy.
